(19) United States
(12) Patent Application Publication
(10) Pub. No.: US 2025/0196559 A1
(43) Pub. Date: Jun. 19, 2025

(54) System and Method for Adjustable Hydraulic Suspension

(71) Applicant: Bollinger Motors Inc., Oak Park, MI (US)

(72) Inventor: Lyth Ahmad Alobiedat, Detroit, MI (US)

(21) Appl. No.: 18/980,385

(22) Filed: Dec. 13, 2024

Related U.S. Application Data
(60) Provisional application No. 63/609,599, filed on Dec. 13, 2023.

(51) Int. Cl. B60G 17/015; B60G 17/019; B60G 17/056

(52) U.S. Cl. CPC B60G 17/0152; B60G 17/019; B60G 17/056; B60G 2202/413

(57) ABSTRACT

A system and method for an improved system and method to control rate of height adjustment for such a suspension mechanism. The system consists of an array of solenoid-actuated valves and pressure sensors. At each suspension corner a sensor monitors fluid pressure, and a valve isolates said corner from a central hydraulic system. The central system consists of hydraulic pump, a sensor monitoring supply pressure, and a proportional valve to control relief to a reservoir. During adjustment, corner valves open to connect to the central system, which is either supplied or relieved of fluid at the desired rate thereby distinguishing away from the prior known suspension systems.

### CROSS REFERENCE TO RELATED APPLICATIONS

This application claims priority to U.S. Provisional Patent Application No. 63/609,599 filed on Dec. 13, 2023 and entitled SYSTEM AND METHOD FOR ADJUSTABLE HYDRAULIC SUSPENSION, which is hereby incorporated by reference.

### TECHNICAL FIELD

The present specification generally relates to vehicle hydraulic systems and, more specifically, a system and method for adjustable hydraulic suspension for electric vehicles.

### BACKGROUND

The evolution of vehicular suspension systems has been driven by the pursuit of an ideal balance between ride comfort and dynamic handling characteristics. Traditional suspension systems, while effective in absorbing shocks and vibrations, often face challenges when confronted with diverse driving conditions, load variations, and driver preferences. Hydraulic suspension mechanisms have emerged as a solution to address these challenges, providing a smoother ride experience by effectively damping disturbances.

A vehicle may include a connected hydraulic suspension mechanism with ride height adjustment to improve ground clearance or aerodynamics. Hydraulic fluid is pumped via external motor into an accumulator at each suspension corner to raise the vehicle. Fluid is relieved to lower the vehicle.

Hydraulic suspension systems typically consist of interconnected hydraulic cylinders, valves, and dampers that work together to control the movement of each wheel independently. While these systems have proven effective in minimizing vertical motion and improving traction, they are often limited in their ability to adapt rapidly to changing conditions. This limitation is particularly evident in scenarios such as sudden acceleration, deceleration, or cornering, where the vehicle's requirements for optimal ride height and suspension stiffness can vary significantly.

However, adjustment rate at each suspension corner may vary greatly depending its load. A highly loaded vehicle may ascend too slowly or lower itself too quickly. The opposite is true for a lightly loaded vehicle. In addition to this problem, uneven loading prevents the vehicle's ability to adjust on a stable plane.

Conventional attempts to address these limitations have involved the incorporation of manually adjustable components or pre-set mechanical systems, which inherently compromise the real-time adaptability of the suspension. As vehicles become more diverse in their applications and drivers increasingly demand a personalized driving experience, there arises a critical need for a suspension system that seamlessly integrates with hydraulic mechanisms while offering dynamic, on-the-fly adjustments for optimal performance and comfort.

The present invention responds to this need by introducing an integrated adjustable suspension system designed to overcome the limitations of loaded vehicles.

Accordingly, there exists a need in the art to provide an improved hydraulic suspension system overcoming the aforementioned disadvantages.

### SUMMARY

A system and method for an improved system and method to control rate of height adjustment for such a suspension mechanism. The system consists of an array of solenoid-actuated valves and pressure sensors. At each suspension corner a sensor monitors fluid pressure, and a valve isolates said corner from a central hydraulic system. The central system consists of hydraulic pump, a sensor monitoring supply pressure, and a proportional valve to control relief to a reservoir. During adjustment, corner valves open to connect to the central system, which is either supplied or relieved of fluid at the desired rate thereby distinguishing away from the prior known suspension systems.

A system providing for adjustable hydraulic suspension of a vehicle depending on load of the vehicle, the suspension having a plurality of suspension corners, the system having a plurality of solenoid-actuated valves, the plurality of solenoid-actuated valves distributed to each of the suspension corners, a plurality of pressure sensors, the plurality of pressure sensors distributed to each of the suspension corners, at each suspension corner a sensor monitors fluid pressure, and a valve (“corner valve”) isolates said corner from a central hydraulic system, a central system, the central system having a hydraulic pump, a sensor monitoring supply pressure, and a proportional valve to control relief to a reservoir, wherein during adjustment, corner valves open to connect to the central system, which is either supplied or relieved of fluid at the desired rate, and wherein load magnitude and distribution affect adjustment rate and balance.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, system may include a plurality of solenoid-actuated valves, the plurality of solenoid-actuated valves distributed to each of the suspension corners. System may also include a plurality of pressure sensors, the plurality of pressure sensors distributed to each of the suspension corners. System may furthermore include at each suspension corner a sensor monitors fluid pressure, and a valve (corner valve) isolates said corner from a central hydraulic system. System may in addition include a central system, the central system having a hydraulic pump, a sensor monitoring supply pressure, and a proportional valve to control relief to a reservoir; where during adjustment, corner valves open to connect to the central system, which is either supplied or relieved of fluid at the desired rate; where load magnitude and distribution affect adjustment rate and balance. Other embodiments of this aspect include corresponding computer systems, apparatus, and computer programs recorded on one or more computer storage devices, each configured to perform the actions of the methods.

In one general aspect, method may include opening a plurality of solenoid-actuated valves distributed to each of the suspension corners of the vehicle. Method may also include monitoring fluid pressure at each suspension corner using a plurality of pressure sensors distributed to each of the suspension corners. Method may furthermore include isolating each suspension corner from a central hydraulic system using a corner valve at each suspension corner. Method may in addition include utilizing a central system having a hydraulic pump, a sensor monitoring supply pressure, and a proportional valve to control relief to a reservoir. Method may moreover include adjusting the suspension by opening the corner valves to connect to the central system, where the central system is either supplied with or relieved of fluid at a desired rate. Method may also include adjusting the rate and balance of the suspension based on the magnitude and distribution of the load. Other embodiments of this aspect include corresponding computer systems, apparatus, and computer programs recorded on one or more computer storage devices, each configured to perform the actions of the methods.

Implementations may include one or more of the following features. Method the method may include: determining the desired rate of fluid supply or relief based on the monitored fluid pressure at each suspension corner. Method where the step of adjusting the suspension further includes controlling the proportional valve to achieve the desired rate of fluid relief to the reservoir. Method where the step of monitoring fluid pressure further includes transmitting pressure data from the plurality of pressure sensors to a central processing unit for analysis. Method where the step of opening the plurality of solenoid-actuated valves is initiated in response to a change in the vehicle's load. Implementations of the described techniques may include hardware, a method or process, or a computer tangible medium.

### BRIEF DESCRIPTION OF THE DRAWINGS

The embodiments set forth in the Figures are illustrative and exemplary in nature and not intended to limit the subject matter. The following detailed description of the illustrative embodiments can be understood when read in conjunction with the appended Figures, where like structure is indicated with like reference numerals and in which:

FIG. 1 depicts a schematic view of the system for each of the front left (FL), front right (FR), rear left (RL), and rear right (RR) according to one or more embodiments shown and described herein;

FIG. 2 depicts a schematic view of an overview of the central system including the FL, FR, RL, and RR according to one or more embodiments shown and described herein;

FIG. 3 depicts an exemplary schematic view of the system with low position on the front of the vehicle according to one or more embodiments shown and described herein;

FIG. 4 depicts an exemplary schematic view of the system with high position on the all positions of the vehicle according to one or more embodiments shown and described herein; and

FIG. 5 depicts an exemplary schematic view of the system with mixed pressure on the vehicle positions of the vehicle according to one or more embodiments shown and described herein.

### DETAILED DESCRIPTION

The system and method disclosed here recognizes the aforementioned disadvantages and provides for an improved system and method to control rate of height adjustment for such a suspension mechanism. The system consists of an array of solenoid-actuated valves and pressure sensors. At each suspension corner a sensor monitors fluid pressure, and a valve (“corner valve”) isolates said corner from a central hydraulic system. The central system consists of hydraulic pump, a sensor monitoring supply pressure, and a proportional valve (“drain valve”) to control relief to a reservoir. During adjustment, corner valves open to connect to the central system, which is either supplied or relieved of fluid at the desired rate. As stated above, load magnitude and distribution will affect adjustment rate and balance.

The technology described herein pertains to an advanced suspension control system designed to enhance the rate of height adjustment in vehicles or machinery equipped with hydraulic suspension mechanisms. This system addresses existing limitations by incorporating a sophisticated array of solenoid-actuated valves and pressure sensors, which work in unison to ensure precise control over the suspension's height adjustment rate. At each suspension corner, a dedicated pressure sensor continuously monitors the fluid pressure, while a corner valve functions to isolate that specific corner from the central hydraulic system. This setup ensures that each corner of the suspension can be individually managed, thus allowing for more accurate and responsive adjustments to the vehicle's height.

The central hydraulic system plays a pivotal role in this suspension control technology. It comprises a hydraulic pump, a sensor for monitoring supply pressure, and a proportional valve, also referred to as a drain valve, which controls the relief of hydraulic fluid to a reservoir. This central system is tasked with supplying or relieving fluid at a precise rate, as dictated by the demands of the suspension system. During the height adjustment process, the corner valves open to allow fluid communication with the central system. This fluid exchange is meticulously controlled to achieve the desired rate of height adjustment, ensuring that the vehicle maintains optimal balance and stability.

A critical aspect of this system is its ability to adapt to varying load magnitudes and distributions. The load on a vehicle can significantly influence the rate at which the suspension needs to adjust. By employing an array of pressure sensors, the system can dynamically assess the load conditions and make necessary adjustments to the fluid supply or relief rate. This adaptability ensures that the vehicle remains balanced, regardless of changes in load distribution, which is crucial for maintaining safety and comfort during operation.

In summary, this innovative suspension control system offers a refined approach to managing the height adjustment of hydraulic suspension mechanisms. By integrating solenoid-actuated valves and pressure sensors at each suspension corner, along with a central hydraulic system equipped with a proportional valve, the technology provides precise control over fluid dynamics. This level of control allows for responsive and balanced suspension adjustments, accommodating varying load conditions and enhancing overall vehicle performance.

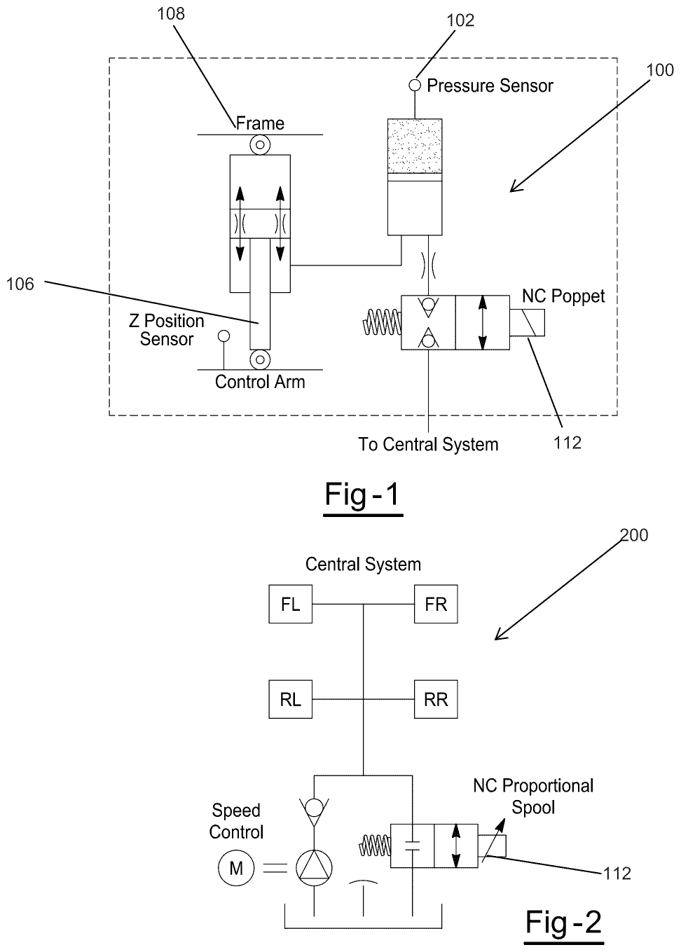

Before adjustment, an assessment of weight distribution is taken by examining the pressure deltas between the central system and each corner. This involves using pressure sensors strategically placed at each corner of the vehicle to measure the real-time pressure exerted by the vehicle's weight. The data collected is then transmitted to a central processing unit that calculates the pressure differential between each corner and the central system. FIG. 1 depicts a schematic view 100 of the system for each of the front left (FL), front right (FR), rear left (RL), and rear right (RR) according to one or more embodiments shown and described herein. The schematic illustrates the integration of pressure sensors 102 and control valves at each corner, which are connected to the central system via hydraulic lines. The system 100 includes the Spool 112, the pressure sensor 104, each in communication with the control arm 106 and a frame 108. A position sensor 110 is also provided in communication with the system 100 as illustrated in FIG. 1.

FIG. 2 depicts a schematic view 200 of an overview of the central system including the FL, FR, RL, and RR according to one or more embodiments shown and described herein. This central system includes a microcontroller that processes input from the pressure sensors and controls the actuation of valves to adjust the pressure distribution. Groups are created with corners (FL, FR, RL, and RR) at similar corner pressures. These groups are dynamically adjusted based on real-time pressure readings to ensure optimal weight distribution. Corners with similar pressure can be relieved simultaneously. This simultaneous relief is achieved through synchronized valve actuation, which is controlled by the central processing unit. If weight distribution is severely unbalanced, higher-pressure corners will flow into lower-pressure corners, causing the vehicle to tilt during adjustment. This flow is regulated by variable orifice valves that modulate the rate of fluid transfer between corners. Once corners are grouped, corners with the highest pressure on descent and lowest pressure on ascent will open first to allow those corners to match the pressure of the other corner groups. This selective opening is controlled by a priority algorithm that determines the sequence of valve actuation. Once pressures are similar during adjustment, then all valves may be open simultaneously. This simultaneous opening is facilitated by a master control signal from the central processing unit, ensuring uniform pressure distribution across all corners.

For descent control, the drain valve will create an orifice to control the rate of descent when the corner valves open. The orifice size is dynamically adjusted based on the current pressure readings and desired descent rate, which are calculated by the central processing unit. A characterization of solenoid position is made by the number of corner solenoids open and pressure exerted on the variable position solenoid. This characterization involves a lookup table stored in the system's memory, which correlates solenoid positions with pressure levels and flow rates. As each corner's solenoid opens or closes, the amount of pressure and rate of fluid flow will change, and a new position from the table is used based on the number of remaining open corner valves left. This dynamic adjustment ensures that the descent is smooth and controlled, preventing abrupt changes in vehicle height. Once a corner valve is open, pressure flows between the corner valve and the central system, and the dynamics of an accumulator take effect to pressure sensor readings. The accumulator acts as a buffer, absorbing sudden changes in pressure and ensuring stable sensor readings. This is why a separate characterization is made by the number of open corner valves. This characterization allows the system to predict and compensate for changes in pressure dynamics as valves open or close.

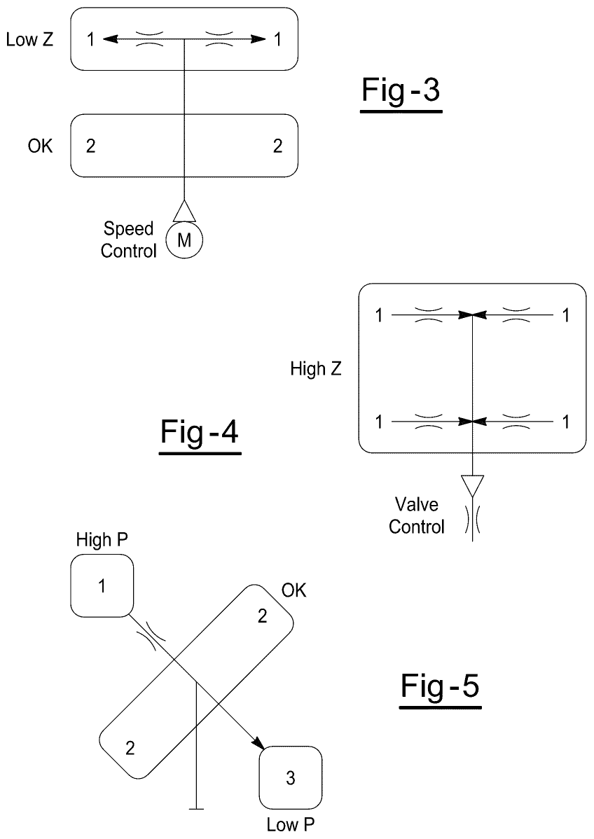

For ascent control, the drain valve is fully closed, and the hydraulic pump will build pressure until the pressure in the central system is greater than the pressure behind the corner valves. The hydraulic pump is equipped with a variable speed drive that adjusts the pump's output based on real-time pressure readings. The valves open based on the strategy mentioned above in specific groups until target pressures and positions are achieved. This strategy involves a feedback loop where pressure sensors continuously monitor the pressure levels, and the central processing unit adjusts valve positions accordingly. If the pressures and positions are similar, the system creates a grouping. This grouping is dynamically updated as pressure readings change, ensuring that the vehicle remains balanced. Fluid is added to the lowest position. This addition is controlled by a proportional valve that modulates the flow rate based on the pressure differential. Fluid is removed from groups with the highest positions. This removal is achieved through a controlled release valve that gradually decreases pressure in the high-pressure groups. If one group of the position targeted and another below, then they equalize to each other. This equalization is facilitated by cross-linking the hydraulic lines between groups, allowing fluid to flow from high-pressure to low-pressure areas. If all at the position target and high pressure, the system equalizes to each other. This equalization is achieved through a centralized control algorithm that adjusts valve positions to balance pressure across all corners. Various embodiments are described herein and illustrated in FIGS. 3-5. These figures depict different scenarios of pressure and position adjustments, showcasing the system's versatility. FIG. 3 depicts an exemplary schematic view of the system with a low position on the front of the vehicle according to one or more embodiments shown and described herein. This schematic illustrates the hydraulic connections and control logic for achieving a low front position. FIG. 4 depicts an exemplary schematic view of the system with a high position on all positions of the vehicle according to one or more embodiments shown and described herein. This view highlights the system's capability to uniformly raise the vehicle. FIG. 5 depicts an exemplary schematic view of the system with mixed pressure on the vehicle positions of the vehicle according to one or more embodiments shown and described herein. This schematic demonstrates the system's ability to handle complex pressure distributions and maintain vehicle stability.

Although the embodiments of the present specification have been illustrated in the accompanying drawings and described in the foregoing detailed description, it is to be understood that the present specification is not to be limited to just the embodiments disclosed, but that the specification described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any Utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

1. A system providing for adjustable hydraulic suspension of a vehicle depending on load of the vehicle, the suspension having a plurality of suspension corners, the system comprising:
a plurality of solenoid-actuated valves, the plurality of solenoid-actuated valves distributed to each of the suspension corners;
a plurality of pressure sensors, the plurality of pressure sensors distributed to each of the suspension corners;
at each suspension corner a sensor monitors fluid pressure, and a valve (“corner valve”) isolates said corner from a central hydraulic system;
a central system, the central system having a hydraulic pump, a sensor monitoring supply pressure, and a proportional valve to control relief to a reservoir;
wherein during adjustment, corner valves open to connect to the central system, which is either supplied or relieved of fluid at the desired rate;
wherein load magnitude and distribution affect adjustment rate and balance.

2. A system for adjustable hydraulic suspension of a vehicle, comprising:
a plurality of suspension corners, each equipped with a solenoid-actuated valve and a pressure sensor; and
a central hydraulic system including a hydraulic pump, a supply pressure sensor, and a proportional valve;
wherein each solenoid-actuated valve isolates its respective suspension corner from the central hydraulic system;
wherein during an adjustment phase, the valves open to connect the suspension corners to the central hydraulic system, which is configured to supply or relieve hydraulic fluid at a desired rate;
wherein the adjustment rate and balance are influenced by load magnitude and distribution.

3. A method for providing adjustable hydraulic suspension of a vehicle depending on the load of the vehicle, the method comprising:
opening a plurality of solenoid-actuated valves distributed to each of the suspension corners of the vehicle;
monitoring fluid pressure at each suspension corner using a plurality of pressure sensors distributed to each of the suspension corners;
isolating each suspension corner from a central hydraulic system using a corner valve at each suspension corner;
utilizing a central system comprising a hydraulic pump, a sensor monitoring supply pressure, and a proportional valve to control relief to a reservoir;
adjusting the suspension by opening the corner valves to connect to the central system, wherein the central system is either supplied with or relieved of fluid at a desired rate; and
adjusting the rate and balance of the suspension based on the magnitude and distribution of the load.

4. The method of claim 3, the method further comprising: determining the desired rate of fluid supply or relief based on the monitored fluid pressure at each suspension corner.

5. The method of claim 3, wherein the step of adjusting the suspension further includes controlling the proportional valve to achieve the desired rate of fluid relief to the reservoir.

6. The method of claim 3, wherein the step of monitoring fluid pressure further includes transmitting pressure data from the plurality of pressure sensors to a central processing unit for analysis.

7. The method of claim 3, wherein the step of opening the plurality of solenoid-actuated valves is initiated in response to a change in the vehicle's load.
